(19) United States
(12) Patent Application Publication
(10) Pub. No.: US 2014/0057140 A1
(43) Pub. Date: Feb. 27, 2014

(54) Reduction of Water Transfer Across Membrane

(71) Applicants: Richard M. Bendert, Kalispell, MT (US); Paula Kosted, Kalispell, MT (US); Gerald P. Backer, Southfield, MI (US)

(72) Inventors: Richard M. Bendert, Kalispell, MT (US); Paula Kosted, Kalispell, MT (US); Gerald P. Backer, Southfield, MI (US)

(73) Assignee: Zinc Air Incorporated, Columbia Falls, MT (US)

(21) Appl. No.: 13/593,732

(22) Filed: Aug. 24, 2012

(51) Int. Cl. H01M 2/38

(52) U.S. Cl. 429/51; 429/91; 429/101

(57) ABSTRACT

A method of operating a redox flow battery includes a step of observing a difference in relative volume between the anolyte fluid volume and the catholyte fluid volume. The ionic molality of anolyte fluid is increased if the relative volume of the anolyte fluid decreases. A redox flow battery having balanced anolyte and catholyte initial ionic molalities is also provided.

### FIELD OF THE INVENTION

The present invention relates to methods and systems for maintaining flow battery systems.

### BACKGROUND OF THE INVENTION

A flow battery is a rechargeable power source which uses an electrochemical cell to generate electricity. A typical flow battery includes an anode side (i.e., negative side) having an anode and an anode chamber and a cathode side (i.e., positive side) having a cathode and a cathode chamber. Each of the anode and cathode chambers contains an electrolyte with dissolved electroactive components. The electrolyte fluid of the anode chamber is referred to as the anolyte fluid while the electrolyte fluid of the cathode chamber is referred to as the catholyte fluid. The anode chamber and cathode chamber are separated by an ion permeable membrane which allows ions to flow between the two chambers. The cathode side also includes a cathode electroactive material that is reduced on discharge of the flow battery. The anode side includes an anode electroactive material that is oxidized on discharge. In certain flow batteries, the cathode side includes a cathode current collector and the anode side includes an anode current collector. In some flow battery designs, an electroactive component may dissolve from an electrode or be deposited onto an electrode.

In a flow battery, the anolyte fluid and catholyte fluid are generally circulated through the respective sides of the cell by way of fluid circulation systems that are external to the electrochemical cell. In many prior art flow batteries, each of the external catholyte and anolyte circulation systems includes an electrolyte reservoir. Charging and discharging of the electrolytes generally takes place in the reactive cell while the electrolytes are stored in their respective reservoirs outside of the cell. Alternatively, charging may be accomplished by replenishing the spent electrolytes in the respective reservoirs with fresh electrolytes.

Although the prior art redox flow systems work well, certain systems experience a change in the volumes of the anolyte fluid and the catholyte fluid which may complicate operation and maintenance.

Accordingly, there is a need for improved redox flow battery designs that reduce or compensate for the movement of ions across the permeable membrane.

### SUMMARY OF THE INVENTION

The present invention solves one or more problems of the prior art by providing in at least one embodiment a method of operating a redox flow battery. The redox flow battery includes an anode, a cathode, an anode chamber, and a cathode chamber. An ion-selective membrane separates the anode chamber and the cathode chamber with anolyte fluid contacting the anode within the anode chamber and catholyte fluid contacting the cathode within the cathode chamber. The redox flow battery also includes an anolyte reservoir and a catholyte reservoir. The anolyte reservoir holds at least a portion of the anolyte fluid which has an initial anolyte fluid volume when present in the anolyte reservoir. The catholyte reservoir holds at least a portion of the catholyte fluid which has an initial catholyte fluid volume when present in the catholyte reservoir. The method includes a step of observing a difference in relative volume between the anolyte fluid volume and the catholyte fluid volume. The ionic molality of anolyte fluid is increased if the relative volume of the anolyte fluid decreases.

In another embodiment, a redox flow battery is provided. The redox flow battery includes an anode, a cathode, an anode chamber, and a cathode chamber. An ion-selective membrane separates the anode chamber and the cathode chamber with anolyte fluid contacting the anode within the anode chamber and catholyte fluid contacting the cathode within the cathode chamber. The redox flow battery also includes an anolyte reservoir and a catholyte reservoir. The anolyte reservoir holds at least a portion of the anolyte fluid which has an initial anolyte fluid volume when present in the anolyte reservoir. The catholyte reservoir holds at least a portion of the catholyte fluid which has an initial catholyte fluid volume when present in the catholyte reservoir. Finally, the redox flow battery also includes a sensor system that detects an exchange of volume between the anolyte reservoir and the catholyte reservoir.

In another embodiment, a redox flow battery having balanced initial ionic molality is provided. The battery of the present embodiment includes an anode, a cathode, an anode chamber, a cathode chamber, anolyte fluid contacting the anode within the anode chamber, and catholyte fluid contacting the cathode within the cathode chamber. An ion-selective membrane separates the anode chamber and the cathode chamber. Characteristically, an initial ionic molality of the anolyte fluid is substantially equal to an initial ionic molality of the catholyte fluid. The flow battery also includes an anolyte reservoir holding at least a portion of the anolyte fluid and a catholyte reservoir holding at least a portion of the catholyte fluid.

### BRIEF DESCRIPTION OF THE DRAWINGS

Exemplary embodiments of the present invention will become more fully understood from the detailed description and the accompanying drawings, wherein:

FIG. 1 is a schematic illustration of an embodiment of a redox flow battery; and

FIG. 2 is a schematic illustration of an embodiment of a redox flow battery based on zinc/iron electrochemistry.

### DESCRIPTION OF THE INVENTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

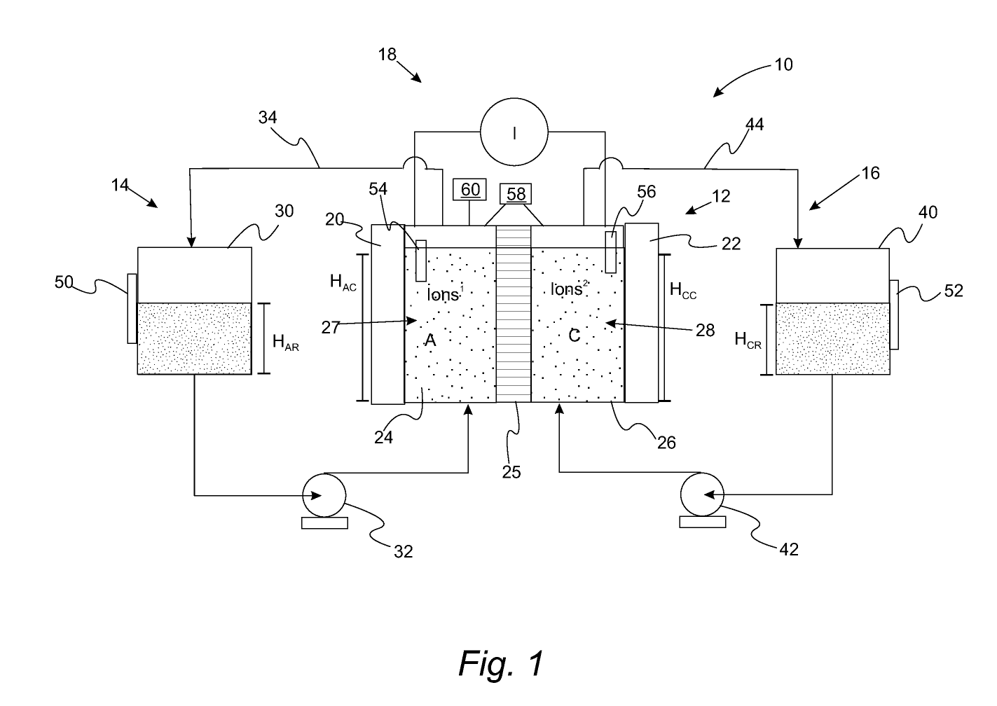

With reference to FIG. 1, a schematic illustration of a redox flow battery system is provided. Redox flow battery system 10 includes reaction cell 12, an anolyte fluid circulation circuit 14, catholyte fluid circulation circuit 16, and an external electrical circuit indicated generally at 18. In a refinement, an anolyte fluid circulation circuit 14 is an anolyte flow system for adding anolyte to the anode chamber while catholyte fluid circulation circuit 16 is a catholyte flow system for adding catholyte to the cathode chamber. Reaction cell 12 includes anode 20, cathode 22, anode chamber 24 and cathode chamber 26. In a variation, anode 20 comprises a component selected from zinc plated on cadmium, cadmium, lead, tin, silver, copper, and brass, and cathode 22 comprises a component selected from the group consisting of nickel foam, sintered nickel, expanded nickel, carbon foam, and carbon matt. Anode chamber 24 and cathode chamber 26 are separated by ion-selective membrane 25. Anode chamber 24 holds anolyte fluid which is generally indicated at 27 while cathode chamber 26 holds catholyte fluid which is generally indicated at 28. It should be appreciated that in the context of the present invention, the term “holds” includes both static holding and transitory holding in which a fluid is flowing or has flowed from or to a chamber or reservoir. In a refinement, the anolyte fluid and the catholyte fluid are each independently water based. The anolyte fluid includes a first plurality of dissolved ions generally indicated by ion¹ while the catholyte fluid includes a second plurality of ions generally indicated by ion². During operation, anolyte fluid is pumped from anolyte reservoir 30 by pump 32 into anode chamber 24 which is subsequently recirculated back into anolyte reservoir 30 via conduit 34. Similarly, during operation, catholyte fluid is pumped from catholyte reservoir 40 by pump 42 into cathode chamber 26 which is subsequently recirculated back into catholyte reservoir 40 via conduit 44. After charging flow battery system 10 with fresh electrolyte fluid (i.e., anolyte fluid and catholyte fluid), the anolyte fluid has an initial concentration of ions ([ion¹]₀) and the catholyte has an initial concentration of ions ([ion²]₀). In addition, the anolyte fluid has an initial anolyte fluid volume when present in anolyte circuit 14 and an initial catholyte fluid volume when present in anolyte circuit 16. In this context, an initial volume refers to the volume when flow battery 10 is charged with fresh electrolytes. This translates into the anolyte fluid having an initial anolyte fluid volume in anolyte reservoir 30 and an initial catholyte fluid volume in the catholyte reservoir 40. Similarly, anode chamber 24 and cathode chamber 26 are each characterized, respectively, by initial catholyte and anolyte fluid volumes. As flow battery system 10 operates, it is observed that the volume of either the anolyte or catholyte fluid decreases (while the volume of the other electrolyte fluid increases) if the ionic molalities of the anolyte and catholyte fluids are not equal. As used herein, the term “ionic molality” refers to the molality (moles/solvent mass) of ions in a fluid. It should also be appreciated that in the context of the present invention, ranges and statements regarding “molality” can be replaced by “molality” since in the operation of the invention these quantities are nearly equal. In practice, the ionic molality is calculated by the concentration of the cations since the concentration of anions is equal to this value. This change in fluid volume is due to the osmotic pressure which is present because of the differing ion concentrations in anode chamber 24 and cathode chamber 26. Therefore, in a variation of the present embodiment, an initial ionic molality of the anolyte fluid is substantially equal to an initial ionic molality of the catholyte fluid (i.e., [ion¹]₀=[ion²]₀). In a refinement, “substantially equal” means that the ionic molalities are within 10 percent of each other. In a refinement, the ionic molalities of the anolyte fluid and the catholyte fluid are within 5 percent of each other. In still another refinement, the ionic molalities of the anolyte fluid and the catholyte fluid are within 1 percent of each other. The initial ionic molalities are calculated by determining the amount of ions generated from the compounds introduced into the anolyte fluid and catholyte fluid for the electrochemical reaction driving battery system 10. If an excess of ions is found in either anolyte fluid or catholyte fluid, additional ions are added to the fluid with the lower ionic molality. In a refinement, these additional ions are introduced by adding to the fluid a compound that dissolves in water. Examples of such compounds that dissolve in water include, but are not limited to, sodium hydroxide, potassium hydroxide, sodium chloride, potassium chloride, sodium bromide, potassium bromide, sodium bicarbonate, and combinations thereof.

Still referring to FIG. 1, the method of the present embodiment includes a step in which a difference in relative volume between the anolyte fluid volume and the catholyte fluid volume is observed. The ionic molality of anolyte fluid is increased if the relative volume of the anolyte fluid decreases. Alternatively, the ionic molality of catholyte fluid is increased if the relative volume of the catholyte fluid decreases. In a variation, the difference in relative volume between the anolyte fluid volume and the catholyte fluid volume is observed by measuring the anolyte fluid volume in anolyte reservoir 30 and the catholyte fluid volume in catholyte reservoir 40. In another variation, the difference in relative volume between the anolyte fluid volume and the catholyte fluid volume is observed by measuring the anolyte fluid volume in anode chamber 24 and the catholyte fluid volume in cathode chamber 26. In a refinement, the difference in relative volume between the anolyte fluid volume and the catholyte fluid volume is estimated by measuring the relative fluid heights in anolyte reservoir 30 indicated by H_{AR} and in catholyte reservoir 40 indicated by H_{CR}. In another refinement, the difference in relative volume between the anolyte fluid volume and the catholyte fluid volume is observed by measuring the relative fluid heights in anode chamber 24 indicated by H_{AC} and in cathode chamber 26 indicated by H_{CC}. In a further refinement, volume sensor 50 is attached to anolyte reservoir 30 and volume sensor 52 is attached to catholyte reservoir 40 in order to measure the respective fluid volumes. In still a further refinement, volume sensor 54 is attached to anode chamber 24 and volume sensor 56 is attached to cathode chamber 26 in order to measure the respective fluid volumes. It should be appreciated that any number of fluid volume sensors may be used for volume sensors 50-54. For example, piezoelectric sensors may be used for this purpose. In a further refinement, redox flow battery system 10 further includes alarm 58 that signals when the anolyte fluid volume is less than the catholyte fluid volume by a predetermined amount or vice versa. In still another refinement, redox flow battery system 10 further includes addition system 60 that increases molality of the anolyte fluid when the anolyte fluid volume is less than the catholyte fluid volume by a predetermined amount.

As set forth above, the molality of the anolyte fluid and the catholyte fluid is balanced if a difference in the respective volumes is observed. In general, the osmotic pressure of the anolyte fluid is adjusted to be within 10% of osmotic pressure of catholyte fluid. In a refinement, the ionic molality of the anolyte fluid is increased if the anolyte fluid volume is less than 90% of the initial anolyte volume. In another refinement, the ionic molality of the anolyte fluid is increased if the anolyte fluid volume is less than 95% of the initial anolyte volume. Similarly, the ionic molality of the catholyte fluid is increased if the catholyte fluid volume is less than 90% of the initial catholyte volume. In another refinement, the ionic molality of the catholyte fluid is increased if the catholyte fluid volume is less than 95% of the initial catholyte volume. In general, the ionic molality of the anolyte fluid or the catholyte fluid is increased by adding a compound that dissolves in water to provide ions (e.g., sodium ions, potassium ions or combinations thereof.) Examples of such compounds that dissolve in water include, but are not limited to, sodium hydroxide, potassium hydroxide, sodium chloride, potassium chloride, sodium bromide, potassium bromide, sodium bicarbonate, and combinations thereof.

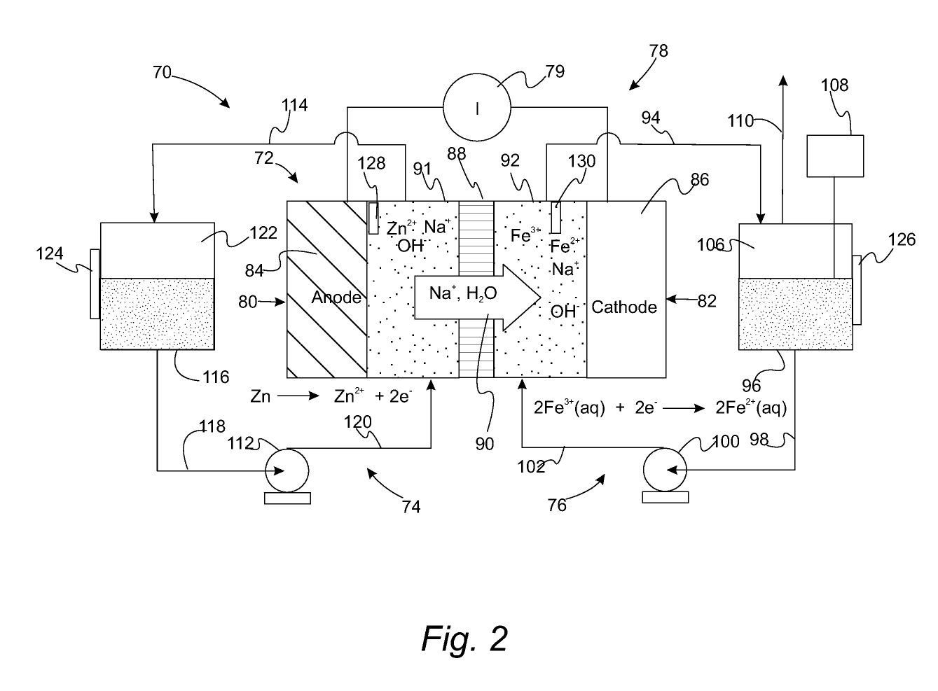

With reference to FIG. 2, a schematic illustration of a redox flow battery system based on zinc/iron electrochemistry is provided. Redox flow battery system 70 includes reaction cell 72, an anolyte fluid circulation circuit 74, catholyte fluid circulation circuit 76, and an external electrical circuit indicated generally at 78. This electric circuit typically includes an electric load 79. Reaction cell 72 includes an anode side 80, and a cathode side 82. In an illustrative variation, anode 84 includes zinc plated on cadmium and cathode 86 includes nickel foam. In the examples depicted in FIG. 2, the electrochemistry characterizing reaction cell 72 is based on zinc-iron with Fe(II) and Fe(III) in a strong base. In this example, the catholyte fluid includes dissolved Na₄Fe(CN)₆ and Na₃Fe(CN)₆. FIG. 2 indicates the presence of ions Zn²⁺, Na⁺, Fe²⁺, Fe³⁺ and Off.

Reaction cell 72 includes ion permeable membrane 88. The movement of ions across cell separator 88 (i.e., an ion-conducting membrane) is indicated at 90. In certain variations, anode chamber 91 and cathode chamber 92 are operated in the fully flooded condition. Other refinements employ a headspace in one or both cell sides over the level of the upper surfaces of the electrolyte fluids. Catholyte fluid circulation circuit 76, for purposes of illustration, comprises a loop around which catholyte fluid is circulated to and from cathode chamber 92. This loop includes cathode chamber 92, catholyte return overflow line 94 from cathode chamber 90 to catholyte reservoir 96, catholyte fluid circulation conduit 98 from catholyte reservoir 96 to catholyte fluid pump 100, and catholyte fluid circulation conduit 102 from catholyte fluid pump 100 to cathode chamber 92 of reactive cell 72. Catholyte reservoir 96 holds catholyte fluid that is excess to the catholyte fluid that is in cathode chamber 92 at any given moment. Catholyte fluid pump 100 pumps catholyte fluid from catholyte reservoir 96 into cathode chamber 92. The hydraulic pressure exerted by catholyte fluid pump 100 also forces catholyte fluid from cathode chamber 92 to catholyte reservoir 96 through catholyte return overflow line 94.

Headspace 106 above the upper surface of the liquid catholyte in catholyte reservoir 96 serves to hold a nitrogen blanket. This nitrogen blanket prevents oxygen from reaching and dissolving in the catholyte fluid in catholyte reservoir 96. In a refinement, nitrogen source 108 is a conventional pressurized tank of nitrogen. In a further refinement, nitrogen accumulates in headspace 106, and is vented through gas purge line 110.

Similarly, anolyte fluid circulation system 74 includes anolyte fluid pump 112 which serves to drive the anolyte fluid around an external loop that includes anode chamber 91, anolyte return overflow line 114, anolyte reservoir 116, anolyte fluid circulation conduit 118, and anolyte fluid circulation conduit 120. Headspace 122 may or may not be purged with nitrogen.

As set forth above, after charging flow battery system 70 with fresh electrolyte fluid (i.e., anolyte fluid and catholyte fluid), the anolyte fluid has an initial concentration of ions ([ion¹]₀) and the catholyte has an initial concentration of ions ([ion²]₀). In addition, the anolyte fluid has an initial anolyte fluid volume when present in anolyte circuit 74 and an initial catholyte fluid volume when present in catholyte circuit 76. Moreover, the anolyte fluid has an initial anolyte fluid volume in anolyte reservoir 116 and an initial catholyte fluid volume in the catholyte reservoir 96. Similarly, anode chamber 91 and cathode chamber 92 are each characterized, respectively, by an initial catholyte fluid volume and an initial anolyte fluid volume. As flow battery system 70 operates, it is observed that the volume of the anolyte fluid decreases while the volume of the catholyte fluid typically increases due to the developing osmotic pressure. Therefore, in a variation of the present embodiment, an initial ionic molality of the anolyte fluid is substantially equal to an initial ionic molality of the catholyte fluid (i.e., ([ion¹]₀=[ion²]₀. In a refinement, “substantially equal” means that the ionic molalities are within 10 percent of each other. In a refinement, the ionic molalities of the anolyte fluid and the catholyte fluid are within 5 percent of each other. In still another refinement, the ionic molalities of the anolyte fluid and the catholyte fluid are within 1 percent of each other. The initial ionic molalities are calculated by determining the amount of ions generated from the compounds introduced into the anolyte fluid and catholyte fluid for the electrochemical reaction driving battery system 10. If an excess of ions is found in either anolyte fluid or catholyte fluid, additional ions are added to the fluid with the lower ionic molality. In a refinement, these additional ions are introduced by adding to the fluid a compound that dissolves in water. Examples of such compounds that dissolve in water, include, but are not limited to, sodium hydroxide, potassium hydroxide, sodium chloride, potassium chloride, sodium bromide, potassium bromide, sodium bicarbonate, and combinations thereof. In a refinement, catholyte side ionic species are in an amount from 1 to 8 molal and anolyte side ionic species are in an amount from 1 to 8 molal.

Still referring to FIG. 2, a method associated with the system of the present embodiment includes a step in which a difference in relative volume between the anolyte fluid volume and the catholyte fluid volume is observed and then the ionic molality of anolyte fluid is increased if the relative volume of the anolyte fluid decreases or the ionic molality of catholyte fluid is increased if the relative volume of the catholyte fluid decreases. In a variation, the difference in relative volume between the anolyte fluid volume and the catholyte fluid volume is observed by measuring the anolyte fluid volume in anolyte reservoir 116 and/or the catholyte fluid volume in catholyte reservoir 96. In another variation, the difference in relative volume between the anolyte fluid volume and the catholyte fluid volume is observed by measuring the anolyte fluid volume in anode chamber 91 and/or the catholyte fluid volume in cathode chamber 92. In a refinement, the difference in relative volume between the anolyte fluid volume and the catholyte fluid volume is estimated by measuring the relative fluid heights in anolyte reservoir 116 indicated by H_{AR} and/or the fluid height in catholyte reservoir 96 indicated by H_{CR}. In another refinement, the difference in relative volume between the anolyte fluid volume and the catholyte fluid volume is observed by measuring the relative fluid heights in anode chamber 91 and in cathode chamber 92 if flow battery system 70 is designed such that there is a headspace in anode chamber 91 and cathode chamber 92. In a further refinement, volume sensor 124 is attached to anolyte reservoir 116 and volume sensor 126 is attached to catholyte reservoir 96 in order to measure the respective fluid volumes. In still a further refinement, volume sensor 128 is attached to anode chamber 91 and volume sensor 130 is attached to cathode chamber 92 in order to measure the respective fluid volumes. It should be appreciated that any number of fluid volume sensors may be used for volume sensors 124-130. For example, piezoelectric sensors may be used for this purpose.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of operating a redox flow battery, the redox flow battery comprising:
an anode;
a cathode;
an anode chamber;
a cathode chamber;
anolyte fluid contacting the anode within the anode chamber;
catholyte fluid contacting the cathode within the cathode chamber;
an anolyte reservoir holding at least a portion of the anolyte fluid, the anolyte fluid having an initial anolyte fluid volume when present in the anolyte reservoir;
a catholyte reservoir holding at least a portion of the catholyte fluid, the catholyte fluid having an initial catholyte fluid volume when present in the catholyte reservoir;
an ion-selective membrane separating the anode chamber and the cathode chamber, the method comprising:
observing a difference in relative volume between the anolyte fluid volume and the catholyte fluid volume; and
increasing ionic molality of anolyte fluid if the relative volume of the anolyte fluid decreases or increasing ionic molality of the catholyte fluid if the relative volume of the catholyte fluid decreases.

2. The method of claim 1 wherein the ionic molality of the anolyte fluid is increased if the anolyte fluid volume is less than 90% of the initial anolyte volume.

3. The method of claim 1 wherein the ionic molality of the anolyte fluid is increased if the anolyte fluid volume is less than 95% of the initial anolyte volume.

4. The method of claim 1 wherein osmotic pressure of the anolyte fluid is adjusted to be within 10% of osmotic pressure of catholyte fluid.

5. The method of claim 1 wherein the ionic molality of the anolyte fluid is increased by adding a compound that dissolves in water to provide sodium ions, potassium ions or combinations thereof.

6. The method of claim 5 wherein the compound that dissolves in water is sodium hydroxide, potassium hydroxide, sodium chloride, potassium chloride, sodium bromide, potassium bromide, sodium bicarbonate, and combinations thereof.

7. The method of claim 1 wherein the anolyte fluid comprises a component selected from the group consisting of sodium ions, potassium ions, and combinations thereof and the catholyte fluid comprises dissolved Na₄Fe(CN)₆ and Na₃Fe(CN)₆.

8. The method of claim 1 wherein a redox flow battery further comprises an anolyte flow system for adding anolyte to the anode chamber and a catholyte flow system for adding catholyte to the cathode chamber.

9. The method of claim 1 wherein the anode comprises zinc plated on cadmium and the cathode comprises nickel foam.

10. A redox flow battery comprising:
an anode;
a cathode;
an anode chamber;
a cathode chamber;
anolyte fluid contacting the anode within the anode chamber;
catholyte fluid contacting the cathode within the cathode chamber;
an anolyte reservoir holding at least a portion of the anolyte fluid;
a catholyte reservoir holding at least a portion of the catholyte fluid;
an ion-selective membrane separating the anode chamber and the cathode chamber; and
a sensor system that detects an exchange of volume between the anolyte reservoir and the catholyte reservoir.

11. The redox flow battery of claim 10 further comprising an addition system that increases molality of the anolyte fluid when the anolyte fluid volume is less than the catholyte fluid volume by a predetermined amount.

12. The redox flow battery of claim 10 further comprising an alarm that signals when the anolyte fluid volume is less than the catholyte fluid by a predetermined amount.

13. The redox flow battery of claim 10 wherein ionic molality of the anolyte fluid is increased if the anolyte fluid volume is less than 90% of the initial anolyte volume.

14. The redox flow battery of claim 10 wherein osmotic pressure of the anolyte fluid is adjusted to be within 10% of the osmotic pressure of the catholyte fluid.

15. The redox flow battery of claim 10 wherein ionic molality of the anolyte fluid is increased by adding a compound that dissolves in water to provide sodium ions, potassium ions or combinations thereof.

16. The redox flow battery of claim 10 wherein the anolyte fluid comprises a component selected from the group consisting of sodium ions, potassium ions and combinations thereof.

17. The redox flow battery of claim 16 wherein the catholyte fluid comprises dissolved Na₄Fe(CN)₆ and Na₃Fe(CN)₆.

18. The redox flow battery of claim 12 wherein a redox flow battery further comprises an anolyte flow system for adding anolyte to the anode chamber and a catholyte flow system for adding catholyte to the cathode chamber.

19. The redox flow battery of claim 10 wherein the anode comprises a component selected from zinc plated on cadmium, cadmium, lead, tin, silver, copper, and brass and the cathode comprises a component selected from the group consisting of nickel foam, sintered nickel, expanded nickel, carbon foam, and carbon matt.

20. A redox flow battery comprising:
an anode;
a cathode;
an anode chamber;
a cathode chamber;
anolyte fluid contacting the anode within the anode chamber;
catholyte fluid contacting the cathode within the cathode chamber, an initial ionic molality of the anolyte fluid being substantially equal to an initial ionic molality of the catholyte fluid;
an anolyte reservoir holding at least a portion of the anolyte fluid;
a catholyte reservoir holding at least a portion of the catholyte fluid; and
an ion-selective membrane separating the anode chamber and the cathode chamber.

21. The redox flow battery of claim 20 wherein the initial ionic molality of the anolyte fluid is within 5 percent of the initial ionic molality of the catholyte fluid.

22. The redox flow battery of claim 20 wherein the initial ionic molality of the anolyte fluid is within 1 percent of the initial ionic molality of the catholyte fluid.

23. The redox flow battery of claim 20 wherein catholyte side ionic species are in an amount from 1 to 8 molal and anolyte side ionic species are in an amount from 1 to 8 molal.
